(19) United States
(12) Patent Application Publication
(10) Pub. No.: US 2026/0365761 A1
(43) Pub. Date: Nov. 19, 2026

(54) METHOD FOR MAKING ALKENE-FUNCTIONALIZED CELLULOSE NANOCRYSTALS FOR APPLICATION IN RUBBER

(71) Applicants: Jeremy John MEHLEM, Greenville, SC (US); COMPAGNIE GENERALE DES ETABLISSEMENTS MICHELIN, Clermont-Ferrand (FR)

(72) Inventors: Wadood Yasser HAMAD, Fribourg (CH); Jeremy John MEHLEM, Greenville, SC (US); Chuanwei MIAO, Richmond (CA)

(21) Appl. No.: 19/117,855

(22) PCT Filed: Oct. 2, 2023
(86) PCT No.: PCT/US23/75690

§ 371 Date: Apr. 2, 2025

Related U.S. Application Data
(60) Provisional application No. 63/412,672, filed on Oct. 3, 2022.

(51) Int. Cl. C08B 3/10; C08B 3/02; C08B 3/12; C08B 11/187; C08B 15/06; C08L 21/00

(52) U.S. Cl. CPC C08B 3/10; C08B 3/02; C08B 3/12; C08B 11/187; C08B 15/06; C08L 21/00

(57) ABSTRACT

This invention addresses functionalizing cellulose nanocrystals (“CNCs”) with a family of alkene-containing molecules to render the nanocrystals suitable for blending with styrene-butadiene or natural rubbers. Alkene-functionalized cellulose nanocrystals (“AFCN”) convert the polar and hydrophilic CNCs into hydrophobic and less-polar nanomaterials, while maintaining the cellulose backbone intact. AFCN can uniformly disperse in rubber and interface well so as to function as effective reinforcing materials. AFCN can be incorporated as a solvent-based paste into the rubber mix or dried via a suitable technique and add as dry powder to the rubber blend then vulcanize using known industrial processes.

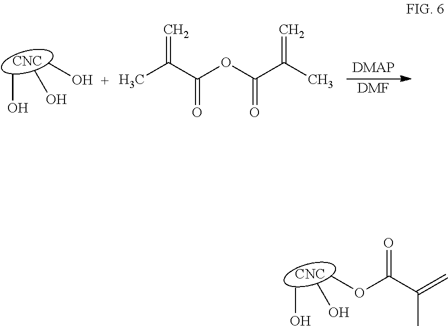

### FIELD OF THE INVENTION

The subject matter of the present invention relates to the incorporation of cellulose nanocrystals after suitable functionalization of alkene-containing molecules onto their surfaces to improve the affinity with the rubber components during blending and vulcanization. The proposed alkene-grafted cellulose nanocrystals maintain the structural backbone and nanoscale dimensions of the nanocrystal leading to a large surface area. This improves both dispersion and interfacial interactions with the rubber ingredients, thereby acting as effective reinforcement.

### BACKGROUND OF THE INVENTION

Several literature reports have described attempts to use pristine unmodified cellulose nanocrystals (“CNCs”), also referred to as “as-received” or “as-prepared” CNC's, and pristine unmodified cellulose nanofibils, (“CNFs”), as a reinforcing filler in styrene-butadiene rubber (“SBR”) as well as natural rubber (NR) and other elastomers, with marginal success. For example Lin, L. et al. Study on the impact of graphene and cellulose nanocrystal on the friction and wear properties of SBR/NR composites under dry sliding conditions. Wear 414-415, 43-49, doi: 10.1016/j.wear.2018.07.027 (2018) discloses less than optimal results when using pristine unmodified CNC's. Yin, B. et al.'s article on “Enhanced mechanical properties of styrene-butadiene rubber with low content of bacterial cellulose nanowhiskers.”, Dominic, C. D. M. et al.'s “Cellulose Nanofibers Isolated from the Cuscuta Reflexa Plant as a Green Reinforcement of Natural Rubber.”, and Visakh, P. M., Thomas, S., Oksman, K. & Mathew, A. P.'s “Crosslinked natural rubber nanocomposites reinforced with cellulose whiskers isolated from bamboo waste: Processing and mechanical/thermal properties.” all describe the use of CNF's with inadequate results. Yin, B. et al. Enhanced mechanical properties of styrene-butadiene rubber with low content of bacterial cellulose nanowhiskers. Advances in Polymer Technology 37, 1323-1334, doi: 10.1002/adv.21791 (2018), Dominic, C. D. M. et al. Cellulose Nanofibers Isolated from the Cuscuta Reflexa Plant as a Green Reinforcement of Natural Rubber. Polymers (Basel) 12, doi: 10.3390/polym12040814 (2020), and Visakh, P. M., Thomas, S., Oksman, K. & Mathew, A. P. Crosslinked natural rubber nanocomposites reinforced with cellulose whiskers isolated from bamboo waste: Processing and mechanical/thermal properties. Composites Part A: Applied Science and Manufacturing 43, 735-741, doi: 10.1016/j.compositesa.2011.12.015 (2012). Polar nanocellulose materials are inherently challenging to disperse in hydrophobic elastomers, particularly for surface sulfated CNCs, where chemical sulfation occurs during the hydrothermal preparation of CNCs. CNCs are negatively charged nanoparticles, and when dried, for instance, spray-dried, it becomes challenging to redisperse even in polar media, and results in large aggregates that show a poor reinforcing effect when used directly as a filler for melt-processed SBR and NR. Surface functionalization is therefore a requirement for (i) the effective dispersibility of CNC powders in nonpolar elastomers, and (ii) the promotion of reinforcing covalent bonds between the well-dispersed CNC particles and the elastomer polymer chains. It is desirable to form covalent crosslinks between filler particles and butadiene polymer chains to achieve favorable viscoelastic properties of vulcanized SBR. Creation of CNCs with alkene functional groups that will covalently bond with the SBR matrix to obtain improved modulus and hysteresis on a level comparable to SBR reinforced with traditional silica or carbon black fillers would be particularly desirable.

CNC reinforcement of vulcanized SBR was reported by Fumagalli and colleagues, describing the gas-phase surface-esterification of CNC with 3,3-dithiopropionic acid chloride (DTACl) to yield disulfide groups that would crosslink with the SBR dienic matrix during vulcanization. Fumagalli, M. et al. Rubber materials from elastomers and nanocellulose powders: filler dispersion and mechanical reinforcement. Soft Matter 14, 2638-2648, doi: 10.1039/C8SM00210J (2018). At a fixed volume fraction of 17% CNC filler in the SBR rubber mixture, the reinforcing effect of disulfide-functionalized CNC over a (non-crosslinking) alkyl-modified CNC was pronounced, with a much greater modulus and strong stress stiffening effect due to the enhanced interfacial interaction. Although a moderate degree of reinforcement was observed here, the gas-phase synthetic process to afford the disulfide-grafted CNC is not amenable to scale.

It would be useful to have a functionalized CNC having superior dispersibility and compatibility in elastomer mixes resulting. It would be further useful if such functionalized CNCs are useful as a reinforcing filler in UV-cured or vulcanized rubber elastomers. In particular a functionalized CNC for use as a reinforcing filler for an elastomer composition and an industrially scalable method of making such fillers would be particularly useful.

### SUMMARY OF THE INVENTION

Aspects and advantages of the invention will be set forth in part in the following description, or may be obvious from the description, or may be learned through practice of the invention.

A cellulose nanocrystal reinforcing filler is disclosed herein. Specifically, a cellulose nanocrystal reinforcing filler having an alkene functionalization and the method of making the same is provided. Either or both terminal and disubstituted alkenes can participate in crosslinking during vulcanization. The proposed synthetic targets are highlighted. The alkene functionalized CNCs attain better dispersion and interfacial interactions with SBR ingredients, thereby functioning as effective reinforcement.

Unsaturated carbon groups, e.g., alkene, can form covalent crosslinks to elastomer polybutadiene groups through sulfide bridges by the same mechanism that elastomer chains inter-crosslinking during vulcanization. The hydrophobic component of the grafted alkene serves to improve the compatibility of the CNCs to enable better mixing, while the alkene group covalently crosslinks with the elastomer during vulcanization or UV-curing.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1. Synthetic pathway and representative products for alkene esterification of CNCs.

FIG. 2. Reactions between CNCs and succinic anhydride-based modification agents.

FIG. 3. FT-IR spectra of CNCs functionalized with succinic anhydride-based agents.

FIG. 4. Reactions of CNC with acyl chlorides.

FIG. 5. Reaction of ED with CNC.

FIG. 6. Reaction between methacrylic anhydride and CNC.

FIG. 7. FT-IR spectra for MA-CNC from two separate reactions confirming reproducibility.

FIG. 8. Reaction schema for CNC with AL (top) and CNC with AI (bottom).

FIG. 9. FT-IR spectra of ODSA-MA-CNC prepared in 1L and 2L scale reactions.

FIG. 10. Solid state 13C NMR spectrum of ODSA-MA-CNC.

The use of identical or similar reference numerals in different figures denotes identical or similar features.

### DETAILED DESCRIPTION OF THE INVENTION

The present invention presents a novel cellulose nanocrystal reinforcing filler for a rubber composition and a method for making the same. For purposes of describing the invention, reference now will be made in detail to embodiments and/or methods of the invention. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

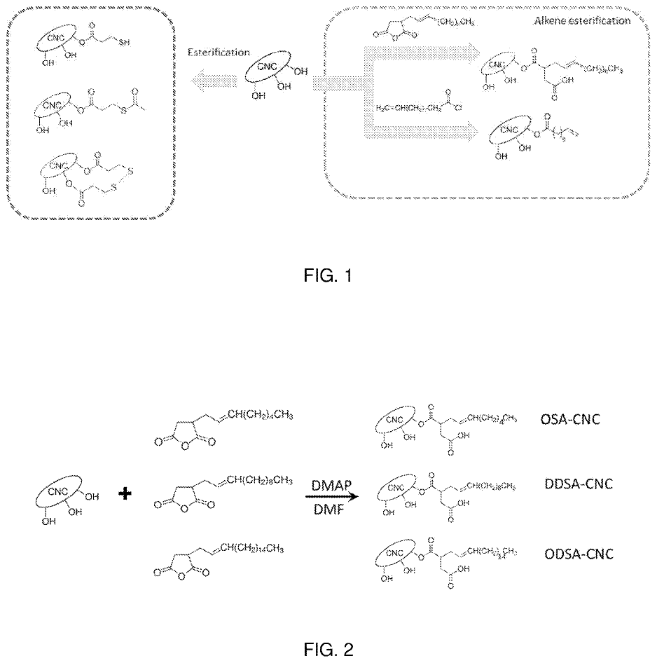

We describe below details of the results for cellulose nanocrystals, (“CNCs”), grafted with alkene functional groups, via different synthetic processes as schematically illustrated in FIG. 1.

The one-step synthesis of alkenyl modified CNCs using succinic anhydride derivatives yields substituted alkene groups with aliphatic chains that will aid in the compatibility of CNCs with SBR. In addition, the unsaturated C—C double bonds on the alkene groups may take part in the crosslinking reactions during rubber vulcanization. For CNC-reinforced elastomers, the carbon chain length may be varied depending on the succinic anhydride group to determine any structure-property effects on compatibility and reinforcement. Typical reaction conditions employ the succinic anhydride in pyridine or dimethylformamide, DMF, solvent, with 4-dimethylaminopyridine (“DMAP”) as a catalyst. Surface functionalization with methacrylate groups can also be carried out to graft short-chain alkenes on CNCs in high density. Further, epoxides, acyl chlorides or isocyanates can be used for the purpose of obtaining terminal-alkene functionalities on CNC, which we expect to have an increased propensity for crosslinking compared to disubstituted alkenes. This approach is summarized using the schematic of FIG. 1, and a list of candidates of the chemicals and their structures presented in Table 1 below. After the reaction, the products are diluted with a solvent, typically acetone, and centrifuged at 4,000 rpm for 20 min. The precipitate was purified by washing with the solvent for two more times through the dispersion-centrifugation cycles. Finally, the wet paste on the centrifuge bottle was collected as the final products and its solid content was measured.

TABLE 1
List of candidate chemicals for grafting alkene groups onto CNC surfaces

| Functional | | | | Chain length | Location |
|---|---|---|---|---|---|
| Group | Abbr. | Name | Structure | (# of C) | of C═C |
| Succinic Anhydride | OSA-CNC | (2-Octen-1-yl) succinic anhydride | 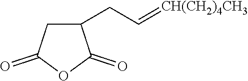 | 8 | Middle |
| | DDSA-CNC | (2-Dodecen-1-yl) succinic anhydride | 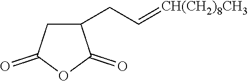 | 12 | Middle |
| | ODSA-CNC | Octadecenyl succinic anhydride | 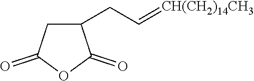 | 18 | Middle |
| Acyl Chloride | UC-CNC | 10-Undecenoyl chloride | 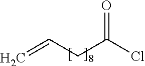 | 10 | End |
| | OC-CNC | Oleoyl chloride | 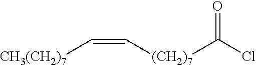 | 17 | Middle |
| Epoxy | ED-CNC | 1,2-Epoxy-9- decene | 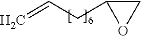 | 8 | End |
| Methacrylic Anhydride | MA-CNC | Methacrylic anhydride | 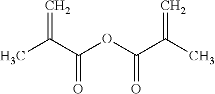 | 3 | End |
| Isocyanate | AL-CNC | Allyl isocyanate | 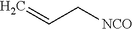 | 3 | End |
| | AI-CNC | 3-Isopropenyl-α,α- dimethylbenzyl isocyanate | 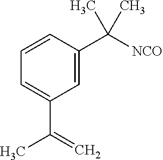 | Aromatic | End |

Three properties were characterized for each alkene modified CNC, including grafting yield, dispersibility in benchmark solvents, and infra-red, (“IR”). The grafting yield is defined as the weight gain based on pristine CNCs loaded in the reaction and was determined gravimetrically. The degree of substitution (DS) was calculated based on that using the equation below:

$$DS = \begin{matrix}{W}_{g} / {MW}_{f} \\ {W}_{CNC} / {MW}_{AGU}\end{matrix} \qquad ( 1 )$$

where: W_{g}=weight gain, MW_{f}=molecular weight of the functionalizing agent, W_{CNC}=weight of CNC in reaction, MW_{AGU}=molecular weight of the anhydroglucose unit of cellulose. This calculation is based on the following assumptions: 1) all unreacted chemicals are removed at the purification step; 2) the weight gain is ascribed to the grafted molecules only; and 3) there is no loss of CNC in the whole process. The benchmark solvents were, in the order of decreasing polarity, ethyl acetate, toluene, d-limonene, and heptane. This test was done to qualitatively evaluate the compatibility between the modified CNC and the rubber matrix as wet functionalized CNCs were directly added into the solvent at a concentration of ~0.1%, followed by sonication of 1-3 min.

There are three types of functionalized CNCs (mCNCs) in this group: OSA-CNC, DDSA-CNC, and ODSA-CNC. They were prepared via the reactions between the OH groups on CNC surfaces and the succinic anhydride groups (see FIG. 2). All reactions can be carried out in CNC/DMF suspension- or a suitable organic solvent where CNCs can be well dispersed, and DMAP is used as the preferred catalyst. The molar ratio of the OH groups on CNC surfaces, the modification agent, and DMAP can ideally be set at 1/1/0.1 for all reactions; however, equivalent ratios are possible as well. The reactions typically proceed for 1 hour at 80 °C under N₂ atmosphere with mechanical stirring. The OSA-CNC can be purified by washing with ethyl acetate, while DDSA-CNC and ODSA-CNC can be purified using acetone. Some of the properties of the three functionalized CNC are shown in Table 2 below.

TABLE 2
Typical properties of CNCs functionalized
with succinic anhydride-based agents.

| | [mCNC] in Wet Paste | | |
|---|---|---|---|
| | (wt. %) | Weight Gain (%) | DS |
| OSA-CNC | 5 | 24 | 0.19 |
| DDSA-CNC | 12 | 33 | 0.20 |
| ODSA-CNC | 12 | 49 | 0.23 |

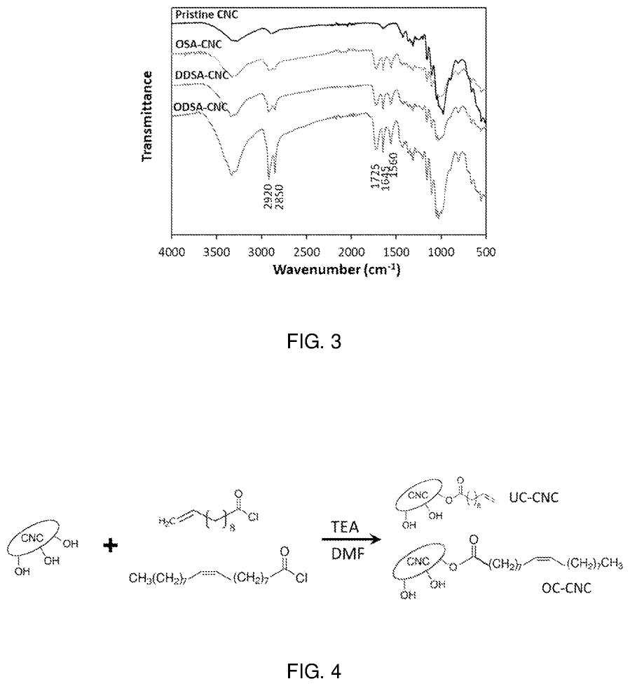

The grafting of alkene chains can be confirmed by Fourier Transform infra-red, FT-IR, spectra of the functionalized CNCs (FIG. 3). Compared to the pristine CNCs, the peak at 1725 cm⁻¹ can be assigned to the carbonyl bonding between CNC and the functionalization agents. The peaks at 1645 cm⁻¹ and 1560 cm⁻¹ belong to C═C and carboxylic groups, respectively. In addition, the peaks at 2920 cm⁻¹ and 2850 cm⁻¹ are ascribed to the CH₂ on the alkene chain and their intensity increases with increasing carbon chain length of the functionalization agents. In dispersibility test, all modified CNCs exhibit significantly improved dispersibility in low polarity solvent. After settling, although the mCNCs precipitated in nonpolar heptane, they could be redispersed readily by shaking.

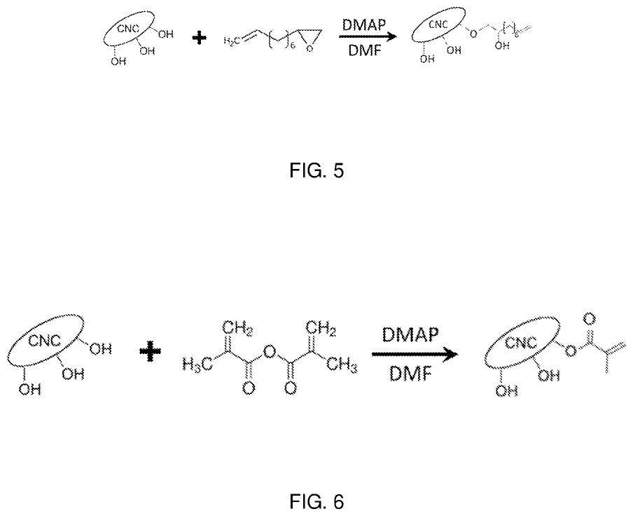

In addition to succinic anhydrides, acyl chlorides, 10-Undecenoyl chloride (UC) and oleoyl chloride (OC), can be used to functionalize CNCs. Their reaction schemes with CNC are shown in FIG. 4. The functionalization reactions can also be carried out in CNC/DMF suspension. The acyl chlorides are to be added into the CNC suspension dropwise under N₂ atmosphere in an ice water bath, and then the flask is moved into a 50 °C oil bath and the reaction continued for 4 hour. Triethylamine (TEA) is typically used in the reaction to neutralize the generated HCl. The molar ratio of the OH (on CNC) with UC/OC and TEA was 1/1/1. The product is typically washed with methanol instead of acetone, as the generated TEA-HCl salt is not soluble in acetone. It is further possible to functionalize CNC surfaces with epoxide, 1,2-epoxy-9-decene (ED) as shown in FIG. 5. Increasing the reaction temperature can improve gravimetric grafting and increase the degree of substitutions, DS. The reaction can typically be carried out in CNC/DMF suspension using DMAP as the catalyst at 80 °C for 4 hour and 100 °C for 5 hour. The molar ratio of OH (on CNC) with ED and DMAP can be set at the ratio: 1/1/0.1. The final products were washed with acetone.

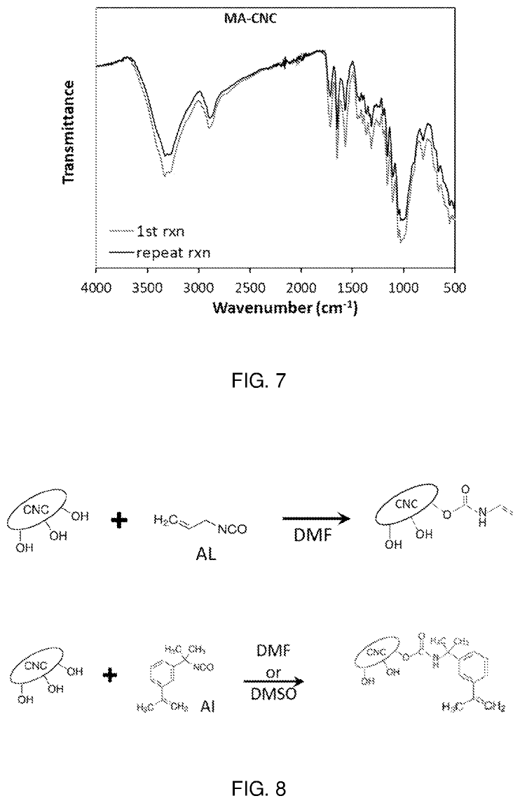

In the family of succinic anhydrides but with the C═C bond at the end and a short carbon chain length, methacrylic anhydride (MA) can be reacted with CNCs (FIG. 6) can be conducted under the same conditions as those for the succinic anhydride functionalization. The molar ratio of OH (on CNC) with MA and DMAP can be set in the range 1/1/0.1. Hydroquinone can be added into the suspension (typically 0.5 wt. % of MA) to exclude any possible effect from the polymerization of the MA molecules. The products can be washed with acetone, and the typical weight gain and degree of substitution, DS, for MA-CNC are in the range 18-20% and 0.4-0.48, respectively. The FT-IR spectra for the MA-CNC samples confirm the effect from MA polymerization is insignificant (see FIG. 7).

It is also possible to use other types of C═C bonds at the end that are short or aromatic chains, for example, allyl isocyanate (AL) and 3-isopropenyl-α,α-dimethylbenzyl isocyanate (AI), respectively. The structure of AL and its reaction with CNC are shown in FIG. 8. Typically, the reactions can be carried out at 80 °C for 4.5 hour under N₂ atmosphere and could proceed for as long as 22 hours for AI.

To balance the plasticizing effect of the long ODSA chains and improve the reinforcing effect in rubber, both ODSA and MA can simultaneously be grafted onto CNC surfaces, where the long ODSA chains can impart compatibility between CNCs and the elastomer, thereby improving CNC dispersion, and the short MA chains provide active sites for crosslinking reaction with SBR ingredients when vulcanized. We can achieve this via a 2-step process to first graft ODSA onto CNC surfaces, followed by MA grafting. However, by taking advantage of the fact that both ODSA and MA grafting reactions can be catalyzed using DMAP, we can conduct the reaction in a scalable one-step procedure. The one-step procedure for grafting ODSA and MA onto CNC surfaces can be controlled by sequential addition of the two chemicals during the reaction. As an example:
150 g of CNC/DMF (CNC concentration=3.5 wt. %) can be added into a 500 mL round bottom flask and purged with nitrogen,
Heat the flask in an 80 °C oil and bath with mechanical stirring,
Add ODSA and DMAP into the flask and the OH/DMAP at a molar ratio of 1/0.1,
Let the reaction proceed for 1 hour, and then add MA into the flask. The MA/OH molar ratio can be set at 1/1,
3 hours after the addition of MA, the reaction can be stopped, and the product washed using acetone via dispersion-centrifugation cycles. The final product is ODSA-MA-CNC wet paste in acetone.

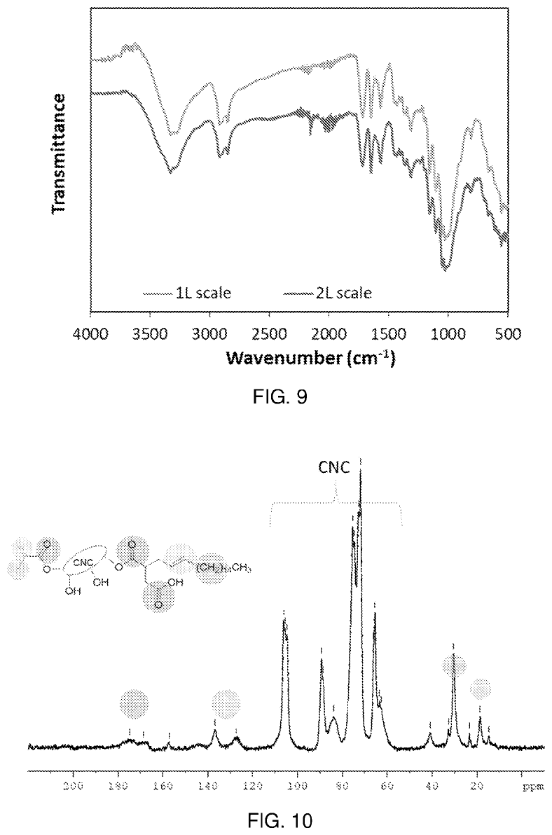

The 1-step reaction can easily be scaled up from 1 to 2 L and more, by proportionally increasing the ratios of the ingredients. The grafting yields are maintained at around 33% and the outcome product is the same as indicated by FT-IR spectra of FIG. 9. Further evidence that the ODSA-MA-CNC reactions proceeded satisfactorily in the one-step reaction can be gleaned from the solid-state ¹³C CPMAS NMR spectrum given in FIG. 10. The assignment of peaks is labelled in the figure, where it is indicated that the characteristic peaks from the grafted ODSA and MA are clearly observed.

The final product can be dried using air drying, vacuum drying, freeze drying, spray drying or any other suitable technique allowing solvents to be directly removed from the system. Subsequently, this dry material can be blended with the rubber ingredients and vulcanized. It is also possible to use the solvent paste containing the functionalized CNCs and be blended directly with the rubber ingredients, while the solvent is allowed to dry. Rubber reinforced with alkene functionalized CNCs exhibit strain behavior ca. 400-500% and a true secant modulus>15 MPa. This material is also characterized by high true secant modulus at low strain values. For instance, at 100% the true secant modulus>10 MPa, and at 200% the true secant modulus is >12 MPa, and at 400% it is >14 MPa.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.”

The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

What is claimed is:

1. A method of functionalizing cellulose nanocrystals using alkene-containing molecules to produce alkene-grafted cellulose nanocrystals comprising:
reacting cellulose nanocrystals with an alkene-containing molecules for 1 hour at temperature below 100 °C under N₂ atmosphere in the presence of a catalyst.

2. The method of functionalizing cellulose nanocrystals of claim 1 wherein acyl chlorides are used and triethylamine is used to neutralize HCl.

3. The method of functionalizing cellulose nanocrystals of claim 1 or 2 wherein succinic anhydrides with carbon chain lengths ranging from 8 to 18 are used.

4. The method of functionalizing cellulose nanocrystals of any one of the above claims wherein acyl chlorides with carbon chains having 10 to 17 carbons that are situated in the middle or end of the molecule are used.

5. The method of functionalizing cellulose nanocrystals of any one of the above claims wherein methacrylic anhydride carbon chains of 3 carbons are used.

6. The method of functionalizing cellulose nanocrystals of any one of the above claims wherein epoxy molecules with an average carbon chain length of 3 carbons or isocyanates with short carbon chain length or aromatic carbon chains are used.

7. The method of functionalizing cellulose nanocrystals of any one of the above claims wherein the degree of substitution (“DS”) is typically between 0.1 and 0.5.

8. The method of functionalizing cellulose nanocrystals of claim 2 wherein the reaction of cellulose nanocrystals with an alkene-containing molecules occurs at a temperature in a range of 75 °C to 85 °C.

9. The method of functionalizing cellulose nanocrystals of claim 3 wherein the reaction of cellulose nanocrystals with an alkene-containing molecules occurs at a temperature of approximately 80 °C.

10. The method of functionalizing cellulose nanocrystals of any one of the above claims wherein the reaction of cellulose nanocrystals with an alkene-containing molecules occurs with a catalyst of 4-dimethylaminopyridine (DMAP).

11. The method of functionalizing cellulose nanocrystals of any of the above claims wherein Triethylamine (TEA) is used to neutralize HCl particularly when acyl chlorides are used.

12. The method of functionalizing cellulose nanocrystals of any of the above claims further comprising:
combining long carbon chain molecules with short carbon chain molecules in a one-step reaction
wherein the alkene-grafted cellulose nanocrystal product is of controlled plasticity and reinforcing contribution when blended with rubber.

13. The method of functionalizing cellulose nanocrystals of claim 12 wherein the long carbon chain molecules are Octadecenyl succinic anhydride.

14. The method of functionalizing cellulose nanocrystals of claim 12 or claim 13 wherein the short carbon chain molecules are Methacrylic Anhydride

15. The method of functionalizing cellulose nanocrystals of any of the above claims further comprising:
drying the final product thereby removing solvents to be directly from the system.

16. The method of functionalizing cellulose nanocrystals of claim 15 wherein the drying method is selected from the group consisting of air drying, vacuum drying, freeze drying or spray drying.

17. The method of functionalizing cellulose nanocrystals of any of the above claims wherein the solvent is partially removed from the system, leaving the functionalized cellulose nanocrystals in a solvent paste.

18. A vulcanized rubber made using a alkene-grafted cellulose nanocrystals made according the method of any one of the above claims.
